(19) United States
(12) Patent Application Publication
(10) Pub. No.: US 2008/0244457 A1
(43) Pub. Date: Oct. 2, 2008

(54) Display Device and Method of Displaying Menus Thereon

(75) Inventors: Sheng-En Tang, Taipei (TW); Tsai-Chung Wang, Taipei (TW); Chun-Ying Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: COMPAL ELECTRONICS, INC., Taipei (TW)

(21) Appl. No.: 11/778,240

(22) Filed: Jul. 16, 2007

(30) Foreign Application Priority Data
Mar. 30, 2007 (TW) 96111395

(51) Int. Cl. G06F 3/048

(52) U.S. Cl. 715/841

(57) ABSTRACT

A display device includes a display screen and a directional element. The display screen includes a first display area and a second display area. The directional element transmits a first trigger signal and a second trigger signal. The first trigger signal informs the first display area to display a directory menu, and the second trigger signal selects an option of the directory menu, so that the second display area can display a sub directory menu corresponding to the selected option. A method of displaying menus on a display device is also disclosed.

### RELATED APPLICATIONS

This application claims priority to Taiwan Application Serial Number 96111395, filed Mar. 30, 2007, which is herein incorporated by reference.

### BACKGROUND

1. Field of Invention

The present invention relates to a display device and a method of displaying menus thereon. More particularly, the present invention relates to a display device and a method of displaying menus thereon with a controlling manner of using a directional key.

2. Description of Related Art

Technological advances have enabled a decrease in the sizes of electronic devices. The decrease in the sizes of electronic devices makes them easier to carry around. However, decreasing the size of a device results in a corresponding decrease in the device screen. Also, the main frame displayed on the smaller screen usually overlaps the menu displayed on the device, such that the displayed directory menu usually covers the main frame when the menu is being surfed. Furthermore, the use of different keys is often necessary to execute different functions when operating electronic products. Accordingly, this places a limitation on how small the electronic devices can be made.

For the foregoing reasons, there is a need to provide a display device, which is suitable for smaller electronic products and can display the main frame and the directory menu respectively, and has an operating element capable of executing different functions as well.

### SUMMARY

It is therefore an object of the present invention to provide a display device and a method of displaying menus thereon, so as to proceed operations of displaying menus, surfing and executing functions on the display device, by using a directional key.

In accordance with one embodiment of the present invention, a display device is provided. The display device includes a display screen and a directional element. The display screen includes a first display area and a second display area. The directional element transmits a first trigger signal and a second trigger signal. The first trigger signal informs the first display area to display a directory menu. The second trigger signal selects an option of the directory menu, so that the second display area can display a sub directory menu corresponding to the option.

In accordance with another embodiment of the present invention, a method of displaying menus on a display device is provided. The method includes the steps of manipulating a directional element toward a first direction, so as to transmit a first trigger signal; displaying a directory menu on a display panel of the display device in accordance with the first trigger signal; manipulating the directional element toward a second direction, so as to transmit a second trigger signal, in which the first direction and the second direction are perpendicular to each other; and selecting an option of the directory menu on the display panel in accordance with the second trigger signal, for the display panel to display a sub directory menu corresponding to the option.

For the foregoing embodiment of the present invention, the display device and the method of displaying menus thereon described above can be used for the electronic products with smaller screens, such that the display areas on the electronic products can be used effectively, and the operations of displaying menus, surfing, sorting and executing functions can be completed by only using a directional key.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 shows a display device and an operating manner thereof according to one embodiment of the present invention;

FIG. 2 shows another operating manner of the display device shown in FIG. 1; and

FIG. 3 shows a flow chart of a method of displaying menus on a display device.

### DESCRIPTION OF THE PREFERRED EMBODIMENTS

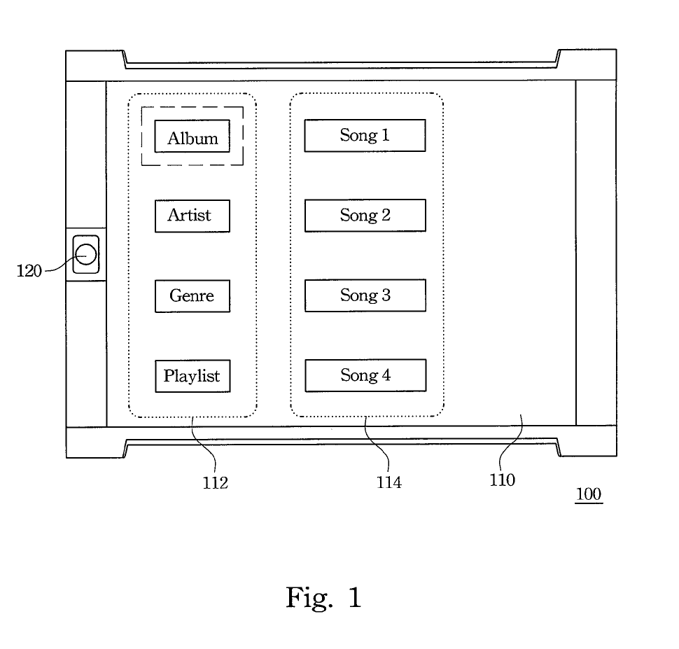

FIG. 1 shows a display device and an operating manner thereof according to one embodiment of the present invention. The display device 100 includes a display screen 110 and a directional element, in which the directional element can be a directional key 120 or a joystick. The display screen 110 includes a first display area 112 and a second display area 114. The directional key 120 transmits a first trigger signal and a second trigger signal. For this embodiment, manipulating the directional key 120 leftward transmits the first trigger signal, and manipulating the directional key 120 upward or downward transmits the second trigger signal. The first trigger signal informs the first display area 112 to display a directory menu, and the second trigger signal selects an option of the directory menu, so that the second display area 114 can display a sub directory menu corresponding to the option.

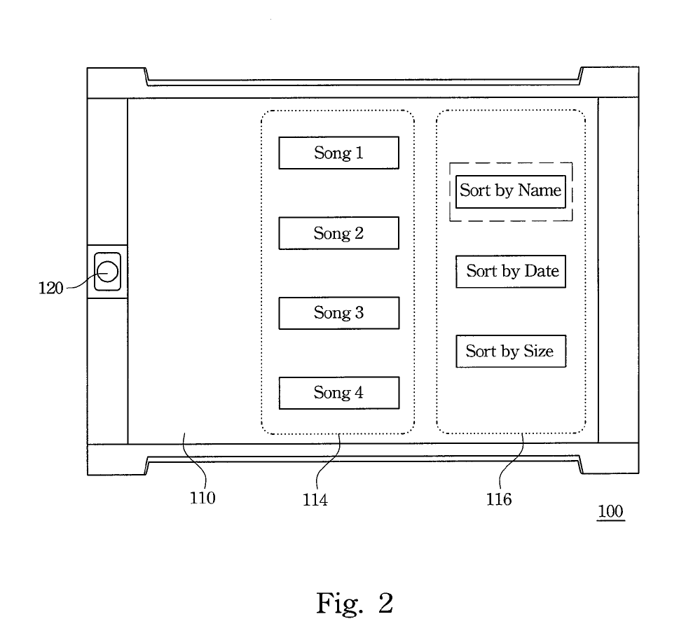

FIG. 2 shows another operating manner of the display device shown in FIG. 1. The display screen 110 can further include a third display area 116, and the directional key 120 can further transmit a third trigger signal. For this embodiment, manipulating the directional key 120 rightward transmits the third trigger signal, so as to inform the third display area 116 to display a second directory menu.

Refer to FIG. 1 and FIG. 2. The directory menu displayed on the first display area 112 is a functional menu, and options of the functional menu show the functions that users are able to execute, so that the second display area 114 can display the sub directory menu corresponding to one of the functional options. The second directory menu displayed on the third display area 116 is a sorting menu, and options of the sorting menu show the ways in which users are able to sort, so that the second display area 114 can display the sub directory menu corresponding to one of the sorting options.

Furthermore, the directional key 120 can further transmit a fourth trigger signal. For this embodiment, manipulating the directional key 120 inward transmits the fourth trigger signal and confirms the option selected from the functional or sorting menu and displays the corresponding sub directory menu on the second display area 114. Then, the options of the sub directory menu are selected by manipulating the directional key 120 upward or downward, so as to proceed operations of the selected option of the sub directory menu.

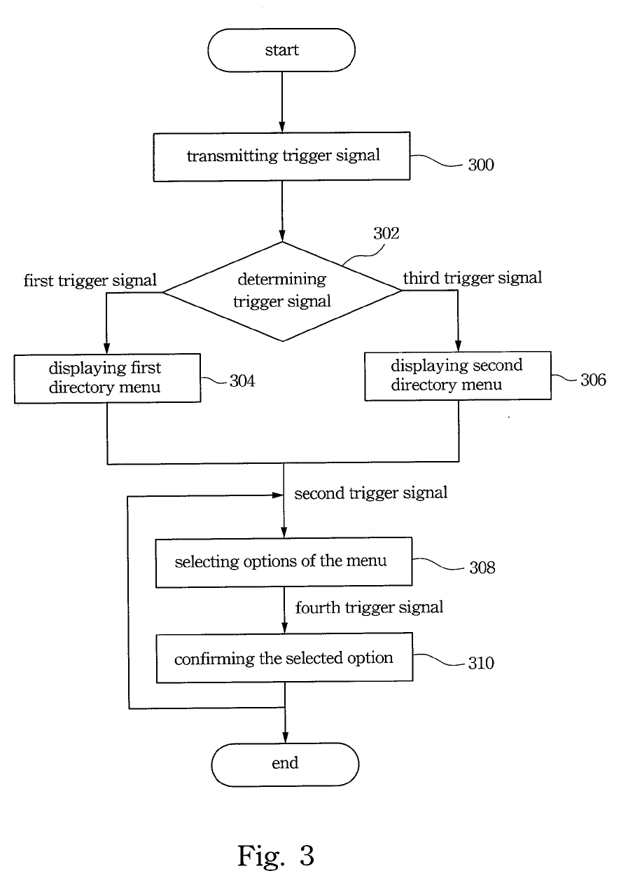

FIG. 3 shows a flow chart of a method of displaying menus on a display device. First, one of the trigger signals is transmitted by a directional element, such as a directional key (Step 300). In one embodiment, the directional element is manipulated in a first direction, such as the leftward direction, so as to transmit a first trigger signal, or is manipulated in a third direction, such as the rightward direction, so as to transmit a third trigger signal, in which the first direction and the third direction are opposite to each other.

Then, the transmitted trigger signal is determined (Step 302), and a directory menu is displayed on a display panel of the display device in accordance with the trigger signal. If the first trigger signal is transmitted, a first directory menu is displayed on the display panel in accordance with the first trigger signal (Step 304). If the third trigger signal is transmitted, a second directory menu is displayed on the display panel in accordance with the third trigger signal (Step 306). The first directory menu can be a functional menu, and options of the functional menu show the functions that users are able to execute. The second directory menu can be a sorting menu, and options of the sorting menu show the ways in which users are able to sort.

After displaying the directory menu, the directional element is manipulated in a second direction, such as the upward or downward direction, so as to transmit a second trigger signal and select one of the options of the directory menu on the display panel in accordance with the second trigger signal (Step 308), so that the display panel can display a sub directory menu corresponding to the option, in which the first direction and the second direction are perpendicular to each other.

After that, the directional element is manipulated in a fourth direction, such as the inward direction, so as to transmit a fourth trigger signal and confirm the selected option of the directory menu in accordance with the fourth trigger signal (Step 310), so that the sub directory menu corresponding to the option of the directory menu can be displayed on the display panel, in which the fourth direction is perpendicular to the first direction and the second direction. If the directory menu is the functional menu, the sub directory menu corresponding to one of the functional options is displayed on the display panel. If the directory menu is the sorting menu, the sub directory menu corresponding to one of the sorting options is displayed on the display panel.

Additionally, if the options of the sub directory menu are going to be selected again, the directional element is manipulated again in Step 308, and the options are selected in accordance with the second trigger signal by manipulating the directional element, and one of the options is then confirmed (Step 310).

For the foregoing embodiment of the present invention, the display device and the method of displaying menus thereon described above can be used for the electronic products with smaller screens, such that the display areas on the electronic products can be used effectively, and the operations of displaying menus, surfing, sorting and executing functions can be completed by using only one directional key.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display device, comprising:
a display screen comprising a first display area and a second display area; and
a directional element for transmitting a first trigger signal and a second trigger signal, wherein the first trigger signal informs the first display area to display a directory menu, and the second trigger signal selects an option of the directory menu, so that the second display area displays a sub directory menu corresponding to the option.

2. The display device as claimed in claim 1, wherein the directory menu displayed on the first display area is a functional menu, and the second display area displays the sub directory menu corresponding to a functional option.

3. The display device as claimed in claim 1, wherein the display device further comprises a third display area, and the directional element further transmits a third trigger signal to inform the third display area to display a second directory menu.

4. The display device as claimed in claim 3, wherein the second directory menu displayed on the third display area is a sorting menu, and the second display area displays the sub directory menu corresponding to a sorting option.

5. The display device as claimed in claim 1, wherein the directional element further transmits a fourth trigger signal to confirm the option selected from the directory menu and to display the corresponding sub directory menu on the second display area.

6. The display device as claimed in claim 1, wherein the second trigger signal is further transmitted to select an option of the sub directory menu, so as to proceed operations of the option of the sub directory menu.

7. The display device as claimed in claim 1, wherein the directional element is a directional key.

8. A method of displaying menus on a display device, comprising:
(a) manipulating a directional element in a first direction, so as to transmit a first trigger signal;
(b) displaying a directory menu on a display panel of the display device in accordance with the first trigger signal;
(c) manipulating the directional element in a second direction, so as to transmit a second trigger signal, wherein the first direction and the second direction are perpendicular to each other; and
(d) selecting an option of the directory menu on the display panel in accordance with the second trigger signal, for the display panel to display a sub directory menu corresponding to the option.

9. The method as claimed in claim 8, wherein the directory menu is a functional menu, and the functional menu is selected to display the sub directory menu corresponding to a functional option on the display panel.

10. The method as claimed in claim 8, further comprising:
manipulating the directional element in a third direction, so as to transmit a third trigger signal, wherein the third direction and the first direction are opposite to each other; and
displaying a second directory menu on the display panel in accordance with the third trigger signal.

11. The method as claimed in claim 10, wherein the second directory menu is a sorting menu, and the sorting menu is selected to display the sub directory menu corresponding to a sorting option on the display panel.

12. The method as claimed in claim 8, further comprising:
manipulating the directional element in a fourth direction, so as to transmit a fourth trigger signal, wherein the fourth direction is perpendicular to the first direction and the second direction; and
confirming the option of the directory menu in accordance with the fourth trigger signal, so as to display the sub directory menu corresponding to the option of the directory menu on the display panel.

13. The method as claimed in claim 8, further comprising:
selecting an option of the sub directory menu on the display panel in accordance with the second trigger signal, so as to proceed operations of the option of the sub directory menu.
